(19) United States
(12) Patent Application Publication
(10) Pub. No.: US 2005/0190778 A1
(43) Pub. Date: Sep. 1, 2005

(54) Multi-system mesh network

(75) Inventor: Fatih Ozluturk, Port Washington, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/013,558

(22) Filed: Dec. 16, 2004

Related U.S. Application Data
(60) Provisional application No. 60/548,327, filed on Feb. 27, 2004.

(51) Int. Cl. H04L 12/56; H04L 12/28

(52) U.S. Cl. 370/406

(57) ABSTRACT

A transmission is simultaneously provided on multiple mesh networks. Retransmission between two nodes may be performed for the same communication along multiple networks in a mesh topography for the multiple networks. This permits communication to be effected in a mesh topography where one or all systems would not be able to provide a complete network connection within any given system.

### CROSS REFERENCE TO RELATED APPLICATIONS

This application claims the benefit of U.S. Patent Application No. 60/548,327, filed Feb. 27, 2004, which is incorporated by reference as if fully set forth.

### FIELD OF INVENTION

The present invention relates to wireless multiuser networks. More particularly, the invention relates to an implementation of a mesh network topology in a multiuser network.

### BACKGROUND

“Network topology” describes the specific physical or logical arrangement of the elements of a network. The elements may be physical or logical such that physical elements are real, and logical elements may be, for example virtual elements or an arrangement of the elements of a network. Two networks may have the same topology if the connection configuration is the same, although the networks may differ in other aspects such as physical interconnections, domains, distances between nodes, transmission rates, and/or signal types. A network may incorporate multiple smaller networks. By way of example, a private telephone exchange is a network and that network is part of a local telephone exchange. The local exchange is part of a larger network of telephones which permit international calls, and is networked with cellular telephone networks.

Wireless networks had in the past embraced a centralized model that holds the potential for bottlenecks, latency and a single point of failure. Wireless mesh networks are emerging as an alternative to wireless switching. Mesh networks distribute intelligence from switches to access points by incorporating a grid like topology. Network intelligence is contained within each access point, and no centralized switches are needed; just intelligent access points with network processors, switching capability and system software. A mesh network allows nodes or access points to communicate with other nodes without being routed through a central switch point, eliminating centralized failure, and providing self healing and self organization. Although decisions on traffic are made locally, the system can be managed globally.

In mesh topography, there are at least two nodes with two or more paths between them. Mesh networks are also defined by network nodes reconfiguring their connections whenever needed to maintain a mesh of nodes that are capable of transporting information from one point to another in a reliable manner. One advantage of mesh networks is that the network has the ability to reconfigure its connections in reaction to some nodes being loaded too much, out of commission, or faulty. Alternatively, the connections are updated simply to find the most efficient way of getting information from one node to another in the same network.

For a network to intercommunicate in a mesh topology, the nodes' self discovery features determine whether they are to serve as access points for wireless devices, as backbones for traffic coming from another node, or a combination of roles. Next, the individual nodes locate their neighbors using discovery query/response protocols. These network protocols are intended to be parsimonious so they do not add much overhead to the traffic; that is, they cannot require more than 1% to 2% of available bandwidth. Once the nodes recognize one another, they measure path information such as received signal strength, throughput, error rate and latency. These values are communicated among the neighbor nodes, but this information must not take up very much bandwidth. Based on these signal values, each node then selects the best path to its neighbors so the optimum quality of service is obtained at any given moment.

The network discovery and path selection processes run in the background, so that each node maintains a current list of neighbors and frequently recomputes the best path. If a node is taken off the network (for maintenance, rearrangements or failure) the adjacent nodes quickly can reconfigure their tables and recompute paths to maintain traffic flow when the network changes. This self healing attribute, or failover, is an advantage of mesh topologies.

Each node is self managed, yet is part of an organized network that can be managed and configured as a single entity from a centralized point. Using standard protocols such as SNMP, a systems administrator can set and monitor individual elements, nodes, domains or an entire network. Discovery protocols simplify the task by seeking out and locating individual nodes for display on management screens.

Mesh topology is inherently reliable and redundant, and can be expanded quickly. A wireless mesh network does not require elaborate planning and site mapping, and nodes can be up and running as soon as administrators mount them. Administrators can fix the problem of a weak signal or dead zone by moving a wireless node or dropping another node into place. With intelligent points on the network dispersed, mesh networks can organize themselves, select the best path for user traffic, route around failures or congestion, and provide secure connections. The decentralization provides for unlimited growth and stability. Networks can be deliberately over-designed for reliability by adding extra nodes; typical mesh networks can expand to hundreds or even thousands of nodes. Mesh networks are implemented in the context of a single air interface or a single network.

Accordingly, mesh networks have limited flexibility, such as range, capacity, data rates, etc. It is desirable to have more flexible mesh networks.

### SUMMARY

According to the present invention, a mesh network architecture includes at least two nodes with two or more paths between them. At least one node communicates within the network according to at least two different system protocols for the same communicated data. The two different system protocols are provided in a manner such that it is possible for a given node to transmit in a first system protocol and receive in a second system protocol. In a particular configuration, the nodes communicating according to the different system protocols establish mesh networks across multiple air interfaces of different networks. In another configuration, the nodes communicating according to the different system protocols establish mesh networks across nodes of different networked systems. The nodes that transmit in one protocol and receive in another protocol form the bridge between these networks and provide cross connections across them.

### BRIEF DESCRIPTION OF THE DRAWINGS

FIG. 1 is a diagram showing an implementation of mesh topography across multiple systems, using the multiple systems.

FIG. 2 is a diagram showing an implementation of mesh topography across multiple systems, in which a wireless transmit/receive unit (WTRU) implements communication across the multiple systems.

FIG. 3 is a schematic block diagram of an integrated circuit (IC) implementation of a communication device capable of multi-mesh communication.

### DETAILED DESCRIPTION OF THE PREFERRED EMBODIMENTS

Hereafter, a wireless transmit/receive unit (WTRU) includes but is not limited to a user equipment, mobile station, fixed or mobile subscriber unit, pager, or any other type of device capable of operating in a wireless environment. When referred to hereafter, a base station includes but is not limited to a Node B, site controller, access point or any other type of interfacing device in a wireless environment.

The invention implements an extension of the mesh networks, in which multiple systems are incorporated into a mesh network topography which is extended across the multiple systems. This allows mesh networking and relaying across different air interfaces. The multi system mesh network fills the coverage holes that each system may have. This provides more ubiquitous coverage as well as the ability to load balance across multiple access networks. According to the present invention instead of limiting mesh network to a single air interface or a single network, multiple network services are used within a single mesh network. Therefore, the mesh networks are formed across different air interfaces or different networks, to achieve better coverage and better network efficiency. The implementation of a system in which mesh networks are formed across multiple air interfaces or across nodes of different networks thereby enhances network operation. Benefits of mesh networking include robustness and better use of system resources. In particular embodiments of the current invention, it is possible to do network optimization and load balancing, as well as recovery from catastrophic events in the network even more effectively and with more benefits. The nodes that transmit in one protocol and receive in another protocol, possibly of different networks or different air interfaces, form the bridge between these networks and provide cross connections across them. This provides a technique for implementation of multi-system mesh networking.

Consider the formation of a mesh network across WLAN and UMTS systems. Data is routed, especially non-real time data, across network nodes some of which are in WLAN system and some are in UMTS system. User traffic can be directed into the WLAN system more and more as more users come into the UMTS system, or vice versa. As far as coverage benefits, in this particular WLAN/UMTS example, smaller isolated WLAN systems can be connected over the nodes that are in the UMTS system. As a result, the coverage ability increases. The interface between the UMTS and WLAN networks in this example is created by the nodes that are capable of receiving in one system and transmiting in the other. In other words these multi-mode nodes provide a path for the data to transition from one network to the other as it travels from node to node within the mesh network. In such a configuration, the end nodes of the mesh network do not have to be involved in providing the interface and be connected to one respective network only.

In one embodiment of the invention, communications received at a node within a network are transferred to other nodes according to a mesh network topography. At least one of the nodes is able to receive in one network system and transmit in a second network system. The retransmission in a second network system renders a mesh topography in the second system which is operated concurrently with a mesh topography in the first system. This further permits transmissions between two nodes to be performed for the same communication along multiple networks in a mesh topography for the multiple networks. In effect, the data can travel from node to node, not only through nodes belonging to one network or the other, but by taking the most advantageous paths across both networks and transitions between the networks back and forth as it moves along this multi-system mesh network.

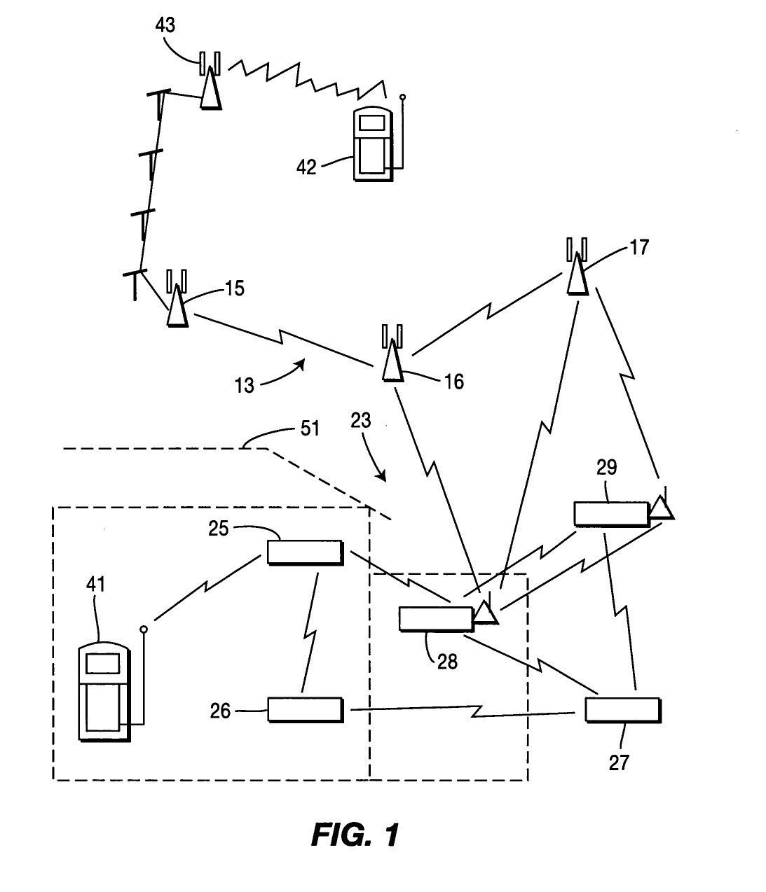

FIG. 1 is a diagram showing an implementation of mesh topography across multiple systems, using the multiple systems. FIG. 1 depicts a first network system 13, which may be a UMTS network, a similar cellular network or other network capable of being modified for mesh communication. The first network system 13 includes multiple base stations 15, 17 which are in wireless or direct hardwire communication. Also shown is a local network system 23 which includes a plurality of local stations 25, 29. Local nodes or access points 25, 29 are in mesh network communication, and the links between nodes 25, 29 may be hardwired or wireless. An example of a local node would be a communication node using an IEEE 802.xx protocol (e.g., IEEE 802.11). Nodes 28, 29 also provide relay communications with the first network system 13. The relay communications permit service to be provided in the first network system 13 and forms an extension of the first network system. Significantly, these nodes 28, 29 provide communications in two network systems 13, 23. The relay functions need not be at the same locations as the WLAN functions, provided that it is possible to provide a connection between the networks 13, 23.

Communication is effected through a WTRU 41 by which a user requests communication. The communication is at least partially performed through the network 13. In the example shown, the communication is to another WTRU 42, shown as connected through a diverse base station 43; however, communications can also or alternatively be established to establish communication with landline based devices. The communications can also be directly linked through a common mesh network with WTRU 41. While WTRUs can be associated with unitary cell phones and the like, WTRUs can also be communication devices associated with diverse units, such as wireless computer modems or repeater devices.

In FIG. 1, the communication link from WTRU 41 is established on a network 23, represented in this case as a WLAN. Nodes 28 and 29 also have an ability to communicate through the UMTS network 13. Network links to node 28 are established thorough nodes 25, 27 in a mesh topography. Node 28 in turn communicates through network 13. In the example shown, node 28 is linked through two base stations 16, 17, and node 29 thorough base station 17. While node 28 is shown as linked to two base stations 16, 17, in the usual case only a single link would be used by a cellular network 13 for most forms of communication with the system 13.

Also nodes 28, 29 have links established between themselves in two systems. Therefore, while nodes 28 and 29 have links in system 23 which includes node 27, nodes 28, 29 also have links which include themselves, as well as base station 17. This establishes mesh network communications in both systems.

When communication is effected between WTRU 41 and a target device 42, communications are established in a mesh network topography within the network system 23 local to WTRU 41, and also in a mesh network topography within network 13. This is particularly convenient if WTRU 41 cannot establish network communication directly with network 13 in a reliable fashion. As depicted by building enclosure 51, it is often the case that communication can be established through a localized network 23, but also use the facilities of a diverse network 13. If communication cannot be established via the local network 23 between WTRU and node 27, it may be possible to link to node 27 using either system 13 or a combination of systems 13 and 23 for the connection to node 27. That means that if there were a discontinuity in the links on either system 13, 23, the links on both systems 13, 23 in combination possibly would be sufficient.

It is further noted that if one system 23 uses mesh topography but the other system 13 does not, the availability of the other system for establishing a link between two nodes 28, 29 in a system 23 with mesh topography enhances the reliability of the system 23 with mesh topography. It is noted that, while air connections are described, it is also possible to implement a mesh network in which some of the links are non-air connections.

In another aspect of the invention, a transmission is simultaneously provided on multiple mesh networks. This enables mesh network operation to take place in a more robust manner. As described infra, retransmission between two nodes may be performed for the same communication along multiple networks in a mesh topography for the multiple networks. This permits communication to be effected in a mesh topography where one or all systems would not be able to provide a complete network connection within any given system.

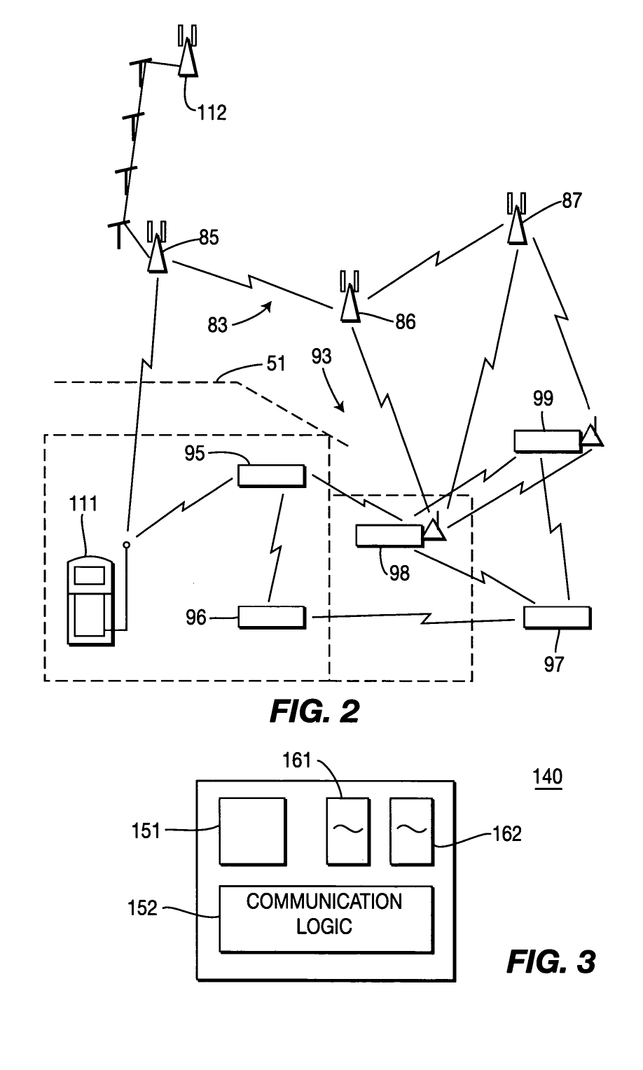

FIG. 2 is a diagram showing an implementation of mesh topography across multiple systems, in which the WTRU implements communication across the multiple systems. A first network system 83 may be a UMTS network, a similar cellular network or other network capable of mesh communication. The first network system 83 includes multiple base stations 85, 87 which are in wireless or direct hardwire communication. Also shown is a local network system 93 which includes a plurality of local stations 95, 99. Local nodes or access points 95, 99 are in mesh network communication, and the links between nodes 95, 99 may be hardwired or wireless. Nodes 98, 99 also provide relay communication with the first network system 83. The relay communication permits service to be provided in the first network system 83 and forms an extension of the first network system. Significantly, these nodes 98, 99 provide communication in two network systems 83, 93.

Communication is effected through a WTRU 111 by which a user establishes communication with another device 112. The communications can also be directly linked thorough a common mesh network with WTRU 111. As is described in connection with FIG. 1, the WTRU 111 in FIG. 2 can be a communication device associated with a diverse unit, such as a wireless computer modem.

The communication link from WTRU 111 is established on local network 93 and on system 83. Communication between WTRU 111 and network system 83 can be either through relay nodes 98, 98 or directly with one of the base stations 85. The simultaneous communications established by WTRU 111 with systems 83, 93 results in a mesh network which includes both. This occurs because at least two nodes have two or more paths between them. Communications can also be established via the relay functions of nodes 98 or 99 to system 83. The relay functions need not be integrated with a WLAN, provided that it is possible to provide a connection between the networks 83, 93.

Nodes 98 and 99 also have an ability to communicate through the UMTS network 83. Network links to node 98 are established thorough nodes 95, 97 in a mesh topography. Node 98 in turn communicates through network 83. In the example shown, node 98 is linked through two base stations 86, 87, and node 99 thorough base station 87. While node 98 is shown as linked to two base stations 86, 87, in the usual case only a single link would be used by a cellular network 83 for most forms of communication with the system 83. Also nodes 98, 99 have links established between themselves in two systems. Therefore, while nodes 98 and 99 have links in system 93 which includes node 97, nodes 98, 99 also have links which include themselves, as well as base station 87. This establishes mesh network communications in both systems.

When communication is effected between WTRU 111 and a target device 112, communication is established in a mesh network topography within the network system 93 local to WTRU 111, and also in a mesh network topography within network 83. This is particularly convenient if WTRU 111 cannot establish network communication directly with network 83 in a reliable fashion. As depicted by building enclosure 51, it is often the case that communications can be established through the local network 93, but also use the facilities of a diverse network 83. If communication cannot be established via the local network 93 between WTRU and node 97, it may be possible to link to node 97 using either system 83 or a combination of systems 83 and 93 for the connection to node 97. Likewise, if communications are transmitted through relay access points provided by nodes 98, 99, then communications can be simultaneously provided through the WLAN functions of one or more of the nodes 95 99 on the local network 93. That means that if there were a discontinuity in the links on either system 83, 93, the links on both systems 83, 93 in combination would be sufficient.

It is further noted that if one system 93 uses mesh topography but the other system 83 does not, the availability of the other system for establishing a link between two nodes 98, 99 in a system 93 with mesh topography enhances the reliability of the system 93 with mesh topography.

FIG. 3 is a schematic block diagram of an integrated circuit (IC) implementation 140 of a communication device capable of multi-mesh communication. The IC 140 includes network selection logic 151, communication logic 152, and signal transceiver logic modules 161, 162. The network selection logic controls the communication logic 152. The communication logic 152 controls the signal transceiver logic modules 161, 162 so as to establish communication links across multiple networks as depicted in FIGS. 1 and 2.

Although the features and elements of the present invention are described in the preferred embodiments in particular combinations, each feature or element can be used alone (without the other features and elements of the preferred embodiments) or in various combinations with or without other features and elements of the present invention. For example, while the above examples described a mesh network in terms of wireless communication, the invention can also be used with hardwired mesh networks.

1. A mesh network architecture, in which at least two nodes with two or more paths between them, wherein at least one node communicates within the network according to at least two different system protocols for the same communicated data.

2. The mesh network architecture of claim 1, wherein said node communication according to at least two different system protocols receives in a first system protocol and transmits in a second system protocol.

3. The mesh network architecture of claim 1, wherein said node communication according to at least two different system protocols receives in a first system protocol and transmits in a second system protocol, and at least one other node receives in the second system protocol and transmits in at least on of said one system protocol or a third system protocol.

4. The mesh network architecture of claim 1, wherein the nodes communicating according to the different system protocols establish mesh networks across multiple air interfaces of different networks.

5. The mesh network architecture of claim 1, wherein the nodes communicating according to the different system protocols establish mesh networks across nodes of different networked systems.

6. The mesh network architecture of claim 1, wherein the nodes communicating according to the different system protocols establish mesh networks across one of multiple air interfaces of different networked systems or nodes of different networked systems.

7. The mesh network architecture of claim 1, wherein the nodes communicating according to the different system protocols establish mesh networks across one of multiple air interfaces of different networked systems or nodes of different networked systems, the different networked systems including WLAN and UMTS systems, thereby permitting routing of data across a combination of said WLAN and UMTS systems.

8. The mesh network architecture of claim 1, wherein:
the network transfers communication received at a node within a network to other nodes according to a mesh network topography;
at least one of the nodes receives in one network system and transmits in a second network system;
the retransmission in the second network system renders a mesh topography in the second system operated concurrently with a mesh topography in the first system; and
the network provides transmissions for the same communication between two nodes along multiple networks in a mesh topography for the multiple networks.

9. The mesh network architecture of claim 1, wherein:
the network substantially simultaneously receives communication at a node within a network in multiple system formats for transmission to corresponding multiple systems to other nodes according to a mesh network topographies under each of said system formats; and
the network provides transmissions for the same communication between two nodes along multiple networks in a mesh topography for the multiple networks.

10. A method of communicating in a mesh network, the method comprising:
determining multiple communication routes for communicating between two nodes, and communicating simultaneously through the multiple communication routes, in which at least two nodes provide communication links along the two different routes; and
using at least two different communication protocols so as to establish the multiple communication routes along the two different protocols, wherein at least one node communicates within the network according to the two different system protocols for the same communicated data.

11. The method of claim 10, wherein said node communication communicating simultaneously through the multiple communication routes receives in a first system protocol and transmits in a second system protocol.

12. The method of claim 10, wherein said node communication according to at least two different system protocols receives in a first system protocol and transmits in a second system protocol, and at least one other node receives in the second system protocol and transmits in at least on of said one system protocol or a third system protocol.

13. The method of claim 10, wherein the nodes communicating according to the different system protocols establish mesh networks across multiple air interfaces of different networks.

14. The method of claim 10, wherein the nodes communicating according to the different system protocols establish mesh networks across nodes of different networked systems.

15. The method of claim 10, wherein the nodes communicating according to the different system protocols establish mesh networks across one of multiple air interfaces of different networked systems or nodes of different networked systems.

16. The method of claim 10, wherein the nodes communicating according to the different system protocols establish mesh networks across one of multiple air interfaces of different networked systems or nodes of different networked systems, the different networked systems including WLAN and UMTS systems, thereby permitting routing of data across a combination of said WLAN and UMTS systems.

17. The method of claim 10, wherein:
the network transfers communication received at a node within a network to other nodes according to a mesh network topography;
at least one of the nodes receives in one network system and transmits in a second network system;
the retransmission in the second network system renders a mesh topography in the second system operated concurrently with a mesh topography in the first system; and
the network provides transmissions for the same communication between two nodes along multiple networks in a mesh topography for the multiple networks.

18. The method of claim 10, wherein:
the network substantially simultaneously receives communication at a node within a network in multiple system formats for transmission to corresponding multiple systems to other nodes according to a mesh network topographies under each of said system formats; and
the network provides transmissions for the same communication between two nodes along multiple networks in a mesh topography for the multiple networks.

19. A semiconductor circuit device for communicating in a mesh network, the circuit device comprising:
a circuit for determining multiple communication routes for communicating between two nodes, and communicating simultaneously through the multiple communication routes, in which at least two nodes provide communication links along the two different routes; and
a circuit for using at least two different communication protocols so as to establish the multiple communication routes along the two different protocols, wherein at least one node communicates within the network according to the two different system protocols for the same communicated data, wherein the communicating according to the different system protocols establishes mesh networks across one of multiple air interfaces of different networked systems or nodes of different networked systems.
